(19) United States
(12) Patent Application Publication
(10) Pub. No.: US 2023/0161403 A1
(43) Pub. Date: May 25, 2023

(54) METHOD FOR MANAGING TRACKING SENSORS, TRACKING DEVICE, AND COMPUTER READABLE STORAGE MEDIUM

(71) Applicant: HTC Corporation, Taoyuan City (TW)

(72) Inventor: Chao Shuan Huang, Taoyuan City (TW)

(73) Assignee: HTC Corporation, Taoyuan City (TW)

(21) Appl. No.: 17/706,621

(22) Filed: Mar. 29, 2022

Related U.S. Application Data
(60) Provisional application No. 63/281,740, filed on Nov. 22, 2021.

(51) Int. Cl. G06F 3/01; G06T 7/246; G06F 3/0346; G01S 1/70

(52) U.S. Cl. CPC G06F 3/012; G06T 7/246; G06F 3/0346; G01S 1/70

(57) ABSTRACT

The embodiments of the disclosure provide a method for managing tracking sensors, a tracking device, and a computer readable storage medium. The method includes: obtaining a first sensing data of a first tracking sensor of the tracking sensors; determining a first sensing result of a first tracking sensor of the tracking sensors; and in response to the first sensing result of the first tracking sensor indicates that the first tracking sensor corresponds to an untrackable status, decreasing a first sensing rate of the first tracking sensor.

### CROSS-REFERENCE TO RELATED APPLICATION

This application claims the priority benefit of U.S. provisional application Ser. No. 63/281,740, filed on Nov. 22, 2021. The entirety of the above-mentioned patent application is hereby incorporated by reference herein and made a part of this specification.

### BACKGROUND

### 1. Field of the Invention

The present disclosure generally relates to a tracking mechanism, in particular, to a method for managing tracking sensors, a tracking device, and a computer readable storage medium.

### 2. Description of Related Art

See FIG. 1A and FIG. 1B, which show the appearance of head-mounted displays (HMD) disposed with tracking sensors. In FIG. 1A, the HMD 101 has several tracking sensors disposed at the positions labelled with circles, wherein the tracking sensors on the HMD 101 can be cameras used to capture images of the environment where the HMD 101 locates. In this case, the HMD 101 can perform, for example, an inside-out tracking mechanism to track the pose of the HMD 101 based on the images captured by the cameras.

In FIG. 1B, the HMD 102 also has several tracking sensors disposed at the positions labelled with circles, wherein the tracking sensors on the HMD 102 can be beacon sensors that receives beacons emitted from one or more external beacon source (e.g., a base station of a virtual reality (VR) system). In this case, the HMD 102 can perform, for example, an outside-in tracking mechanism to track the pose of the HMD 102 based on the received beacons.

Although the tracking accuracy can be improved by disposing more tracking sensors on a tracking device (e.g., the HMD of a VR system), more power would be consumed as well. The power consumption would be increased when using tracking sensor with high frequency/resolution.

In addition, more tracking sensors means more data flow would be inputted to the processor of the tracking device, which not only occupies computation resource but also consumes lots of power, which induces more heat and less battery life. In order to reduce the heat, some cooling mechanism (e.g., a fan) has to be disposed within the tracking devices, which would increase the weight of the tracking devices.

Since the design of the tracking devices (e.g., the HMD) tends to be smaller and lighter, it is crucial to develop a better design of tracking devices to reduce the power consumption and heat.

### SUMMARY OF THE INVENTION

Accordingly, the disclosure is directed to a method for managing tracking sensors, a tracking device, and a computer readable storage medium, which may be used to solve the above technical problems.

The embodiments of the disclosure provide a method for managing tracking sensors, adapted to a tracking device having a plurality of tracking sensors. The method includes: obtaining a first sensing data of a first tracking sensor of the tracking sensors; determining a first sensing result of a first tracking sensor of the tracking sensors; and in response to the first sensing result of the first tracking sensor indicates that the first tracking sensor corresponds to an untrackable status, decreasing a first sensing rate of the first tracking sensor.

The embodiments of the disclosure provide a tracking device including a plurality of tracking sensors, a storage circuit, and a processor. The storage circuit stores a program code. The processor is coupled to the tracking sensors and the storage circuit, and accesses the program code to perform: obtaining a first sensing data of a first tracking sensor of the tracking sensors; determining a first sensing result of a first tracking sensor of the tracking sensors; in response to the first sensing result of the first tracking sensor indicates that the first tracking sensor corresponds to an untrackable status, decreasing a first sensing rate of the first tracking sensor.

The embodiments of the disclosure provide a non-transitory computer readable storage medium, the computer readable storage medium recording an executable computer program, the executable computer program being loaded by a tracking device to perform steps of: obtaining a first sensing data of a first tracking sensor of the tracking sensors; determining a first sensing result of a first tracking sensor of the tracking sensors; and in response to the first sensing result of the first tracking sensor indicates that the first tracking sensor corresponds to an untrackable status, decreasing a first sensing rate of the first tracking sensor.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1A and FIG. 1B show the appearance of head-mounted displays (HMD) disposed with tracking sensors.

FIG. 2 shows a schematic diagram of a tracking device according to an embodiment of the disclosure.

FIG. 3 shows schematic diagrams of an environment where the tracking device locates according to an embodiment of the disclosure.

FIG. 4 shows a flow chart of the method managing tracking sensors according to an embodiment of the disclosure.

FIG. 5 shows a schematic diagram of the sensing rate adjustment of several tracking sensors according to an embodiment of the disclosure.

FIG. 6 shows a schematic diagram of the sensing rate adjustment of several tracking sensors according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

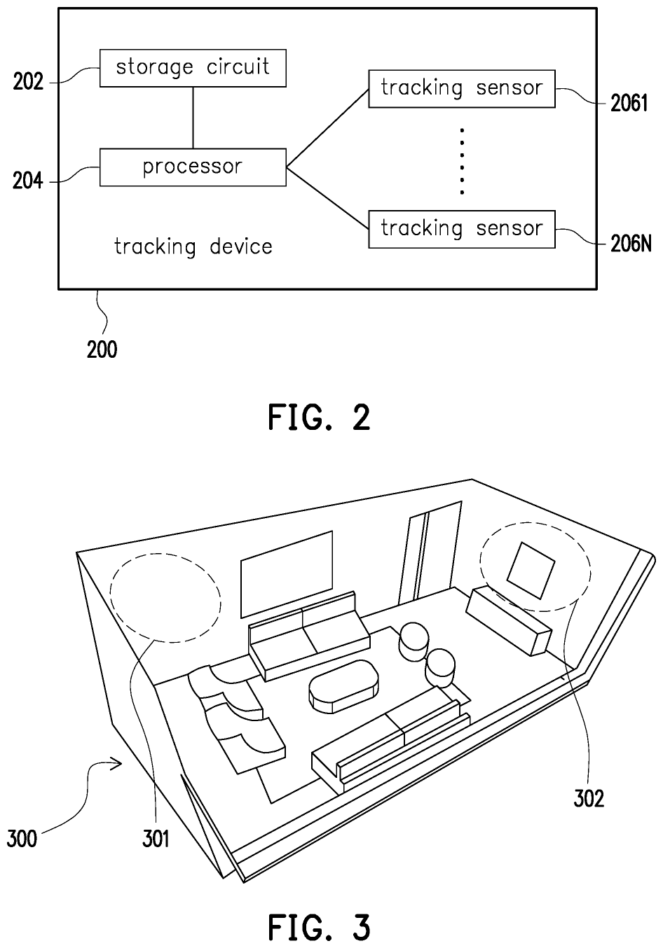

See FIG. 2, which shows a schematic diagram of a tracking device according to an embodiment of the disclosure. In various embodiments, the tracking device 200 can be any device that is capable of performing tracking functions (e.g., inside-out tracking and/or outside-in tracking), such as one or a combination of a handheld controller (e.g., a VR handheld controller), a HMD, and a tracker. In one embodiment, the tracker can be an accessory of the VR system, wherein the tracker can be attached to any to-be-tracked object for other device (e.g., the HMD) to track, but the disclosure is not limited thereto.

In FIG. 2, the tracking device 200 includes a storage circuit 202, a processor 204, and a plurality of tracking sensors 2061-206N. The storage circuit 202 is one or a combination of a stationary or mobile random access memory (RAM), read-only memory (ROM), flash memory, hard disk, or any other similar device, and which records a plurality of modules that can be executed by the processor 204.

The processor 204 may be coupled with the storage circuit 202 and the tracking sensors 2061-206N, and the processor 104 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

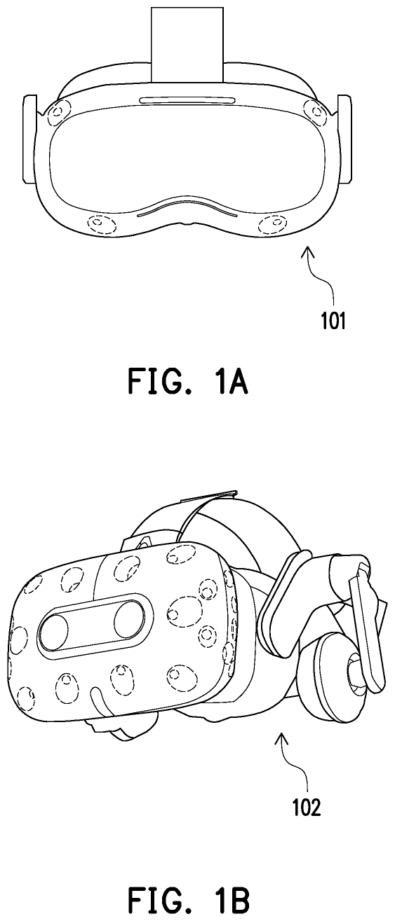

In a first embodiment, the tracking device 200 is implemented as the HMD 101 in FIG. 1A. In this case, the tracking sensors 2061-206N can be the cameras disposed on the tracking device 200 and used for capturing images of the environment where the tracking device 200 locates. For example, for a first tracking sensor (e.g., the tracking sensor 2061) of the tracking sensors 2061-206N, the processor 204 can control the first tracking sensor to capture a plurality of images of the environment and detect a plurality of environmental landmarks in each image. In the embodiments of the disclosure, the term “environmental landmark” can be generally understood as, including but not limited to, features, or any trackable objects in each image. Next, the processor 204 can determine the pose of the tracking device 200 corresponding to each image based the environmental landmarks in each image.

In one embodiment, the processor 204 can perform the mechanisms of detecting environmental landmarks and determining poses based on Simultaneous localization and mapping (SLAM), but the disclosure is not limited thereto.

In one embodiment, for a first image among the images captured by the first tracking sensor, the processor 204 can determine a plurality of first environmental landmarks in the first image as a first sensing result of the first tracking sensor. In this case, the processor 204 can determine whether a number of the first environmental landmarks in the first image is less than an amount threshold. In one embodiment, the amount threshold can be a number of environmental landmarks enough for the processor 204 to accordingly determine the pose of the tracking device 200, but the disclosure is not limited thereto.

In one embodiment, in response to determining that the number of the first environmental landmarks in the first image is less than the amount threshold, the processor 204 can determine that the first sensing result of the first tracking sensor indicates that the first tracking sensor corresponds to the untrackable status. Specifically, if the number of the first environmental landmarks in the first image is less than the amount threshold, it represents that the processor 204 may not be able to perform tracking based on the first environmental landmarks in the first image.

See FIG. 3, which shows schematic diagrams of an environment where the tracking device locates according to an embodiment of the disclosure. In FIG. 3, assuming that the environment 300 is the place where the tracking device 200 locates. In this cases, if the viewpoint of the first tracking senor faces a place without or with only a few landmarks, (e.g., a white wall 301), there may not be many first environmental landmarks in the first image captured by the first tracking sensor. In this case, the processor 204 cannot track the pose of the tracking device 200 based on the first environmental landmarks in the first image, and hence the processor 204 can determine that the first sensing result of the first tracking sensor indicates that the first tracking sensor corresponds to the untrackable status.

On the other hand, in response to determining that the number of the first environmental landmarks in the first image is not less than the amount threshold, the processor 204 can determine that the first sensing result of the first tracking sensor indicates that the first tracking sensor corresponds to a trackable status. Specifically, if the number of the first environmental landmarks in the first image is not less than the amount threshold, it represents that the processor 204 is able to perform tracking based on the first environmental landmarks in the first image. For example, if the viewpoint of the first tracking senor faces a place with lots of features (e.g., an area 302 where one or more pieces of furniture locate), there may be many first environmental landmarks in the first image captured by the first tracking sensor. In this case, the processor 204 can track the pose of the tracking device 200 based on the first environmental landmarks in the first image, and hence the processor 204 can determine that the first sensing result of the first tracking sensor indicates that the first tracking sensor corresponds to the trackable status.

In a second embodiment, the tracking device 200 is implemented as the HMD 102 in FIG. 1B. In this case, the tracking sensors 2061-206N can be the beacon sensors disposed on the tracking device 200 and used for receiving beacons from one or more external beacon source in the environment where the tracking device 200 locates. In one embodiment, the beacons can be laser lights emitted from the external beacon sources (e.g., base stations of the VR system). For example, for a first tracking sensor (e.g., the tracking sensor 2061) of the tracking sensors 2061-206N, the processor 204 can control the first tracking sensor to receive one or more beacons from the external beacon sources. Next, the processor 204 can determine the pose of the tracking device 200 based on the received beacons via performing the outside-in tracking function (e.g., the light house tracking mechanism), but the disclosure is not limited thereto.

In one embodiment, the processor 204 can determine the beacons received by the first tracking sensor as a first sensing result of the first tracking sensor. In this case, the processor 204 can determine whether a number of the beacons received by the first tracking sensor is less than an amount threshold. In one embodiment, the amount threshold can be a number of beacons enough for the processor 204 to accordingly determine the pose of the tracking device 200, but the disclosure is not limited thereto.

In one embodiment, in response to determining that the number of the beacons received by the first tracking sensor is less than the amount threshold, the processor 204 can determine that the first sensing result of the first tracking sensor indicates that the first tracking sensor corresponds to the untrackable status. Specifically, if the number of the beacons received by the first tracking sensor is less than the amount threshold, it represents that the processor 204 may not be able to perform tracking based on the beacons received by the first tracking sensor. For example, if the pose of the tracking device 200 makes the first tracking sensor unable to receive enough beacons (e.g., the first tracking sensor being occluded), the processor 204 cannot track the pose of the tracking device 200 based on the beacons received by the first tracking sensor, and hence the processor 204 can determine that the first sensing result of the first tracking sensor indicates that the first tracking sensor corresponds to the untrackable status.

On the other hand, in response to determining that the number of the beacons received by the first tracking sensor is not less than the amount threshold, the processor 204 can determine that the first sensing result of the first tracking sensor indicates that the first tracking sensor corresponds to a trackable status. Specifically, if the number of the beacons received by the first tracking sensor is not less than the amount threshold, it represents that the processor 204 is able to perform tracking based on the beacons received by the first tracking sensor. For example, if the pose of the tracking device 200 makes the first tracking sensor able to receive enough beacons (e.g., the first tracking sensor being not occluded), the processor 204 can track the pose of the tracking device 200 based on the beacons received by the first tracking sensor, and hence the processor 204 can determine that the first sensing result of the first tracking sensor indicates that the first tracking sensor corresponds to the trackable status.

In other embodiments, a part of the tracking sensors 2061-206N can be implemented as the cameras of the first embodiment, and another part of the tracking sensors 2061-206N can be implemented as the beacon sensors of the second embodiment, such that the tracking sensor 200 can perform the inside-out tracking and the outside-in tracking based on the teachings in the first embodiment and the second embodiment, but the disclosure is not limited thereto.

In some embodiments, the tracking sensors 2061-206N can be also implemented as other kind of sensors whose sensing result and/or sensing data can be used by the processor 204 for determining the pose of the tracking device 200. In this case, one tracking sensor would be regarded as corresponding to the untrackable status when the processor 204 determines that the sensing result and/or sensing data provided by this tracking sensor is not enough for the processor 204 to track the pose of the tracking device 200. On the other hand, one tracking sensor would be regarded as corresponding to the trackable status when the processor 204 determines that the sensing result and/or sensing data provided by this tracking sensor is enough for the processor 204 to track the pose of the tracking device 200, but the disclosure is not limited thereto.

In some embodiments, the tracking sensors 2061-206N can be also implemented as other kind of sensors whose sensing result and/or sensing data can be used by the processor 204 for determining the pose of the tracking device 200. In this case, one tracking sensor would be regarded as corresponding to the untrackable status when the processor 204 determines that the tracking quality, the tracking confidence, and/or the viewpoint of this tracking sensor is unqualified for the processor 204 to track the pose of the tracking device 200. On the other hand, one tracking sensor would be regarded as corresponding to the trackable status when the processor 204 determines that the tracking quality, the tracking confidence, and/or the viewpoint of this tracking sensor is qualified for the processor 204 to track the pose of the tracking device 200, but the disclosure is not limited thereto.

In the embodiments of the disclosure, each of the tracking sensors 2061-206N has its own sensing rate. Taking the aforementioned first tracking sensor as an example, the first tracking sensor has a first sensing rate for providing the corresponding sensing result and/or sensing data.

In the first embodiment where the first tracking sensor is a camera, the first sensing rate can be the corresponding frame rate of the first tracking sensor. For example, when the first sensing rate is K frame per second (fps), the first tracking sensor would capture one image every 1/K second, wherein K can be 30, 60, 90, etc.

In the second embodiment where the first tracking sensor is a beacon receiver, the first sensing rate can be the rate of the first tracking sensor being triggered to receive beacons. For example, when the first sensing rate is K times per second (fps), the first tracking sensor would be triggered to receive the beacons every 1/K second, wherein K can be desired values of the designer etc.

In the embodiments of the disclosure, the sensing rate of each of the tracking sensors 2061-206N can be adaptively adjusted based on the corresponding sensing result, such that the power consumption of the tracking device 200 can be reduced.

In the embodiments of the disclosure, the processor 204 can access the modules stored in the storage circuit 202 to implement the method for managing tracking sensors provided in the disclosure, which would be further discussed in the following.

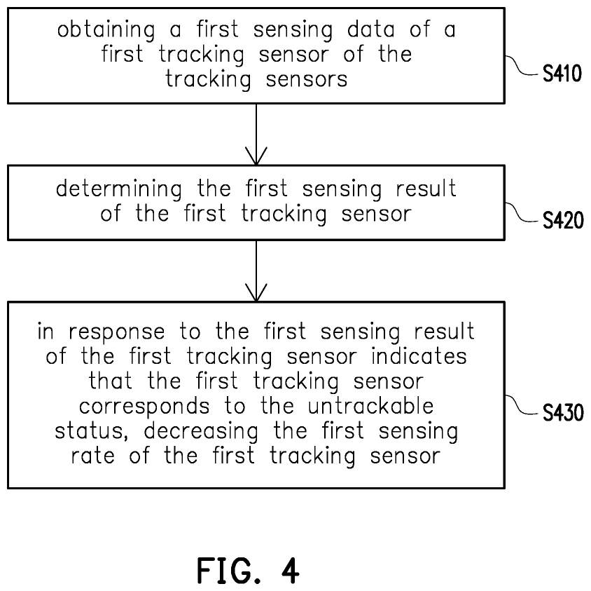

See FIG. 4, which shows a flow chart of the method managing tracking sensors according to an embodiment of the disclosure. The method of this embodiment may be executed by the tracking device 200 in FIG. 2, and the details of each step in FIG. 4 will be described below with the components shown in FIG. 2. In addition, the first tracking sensor would be used as an example for better explaining the concept of the disclosure, and the operations corresponding to other tracking sensors can be understood based on the teachings in the following.

In step S410, the processor 204 obtain a first sensing data of a first tracking sensor of the tracking sensors. In various embodiments, the first sensing data can include any data sensed by the first tracking sensor.

In step S420, the processor 204 obtains the first sensing result of the first tracking sensor. In various embodiments, the first sensing result of the first tracking sensor can be obtained based on the teachings in the above embodiments, which would not be repeated herein.

In some embodiments, the first sensing result determined based on the first sensing data can also be characterized by the tracking quality of the first tracking sensor, the tracking confidence of the first tracking sensor, and/or the viewpoint of the first tracking sensor, but the disclosure is not limited thereto. The mechanisms for determining the tracking quality, the tracking confidence, and/or the viewpoint based on the first sensing data can be referred to the related prior arts.

In one embodiment, the processor 204 can determine whether the first sensing result of the first tracking sensor indicates that the first tracking sensor corresponds to the untrackable status. If the first sensing result of the first tracking sensor indicates that the first tracking sensor corresponds to the trackable status, it represents that the sensing result and/or sensing data provided by the first tracking sensor is enough for the processor 204 to track the pose of the tracking device 200. In this case, the processor 204 can maintain the first sensing rate of the first tracking sensor, such that the first tracking sensor can continuously provide useful information for the processor 204 to perform pose tracking, but the disclosure is not limited thereto.

On the other hand, if the first sensing result of the first tracking sensor indicates that the first tracking sensor corresponds to the untrackable status, it represents that the sensing result and/or sensing data provided by the first tracking sensor may be not enough for the processor 204 to track the pose of the tracking device 200.

Therefore, in step S430, in response to determining that the first sensing result of the first tracking sensor indicates that the first tracking sensor corresponds to the untrackable status, the processor 204 decreases the first sensing rate of the first tracking sensor.

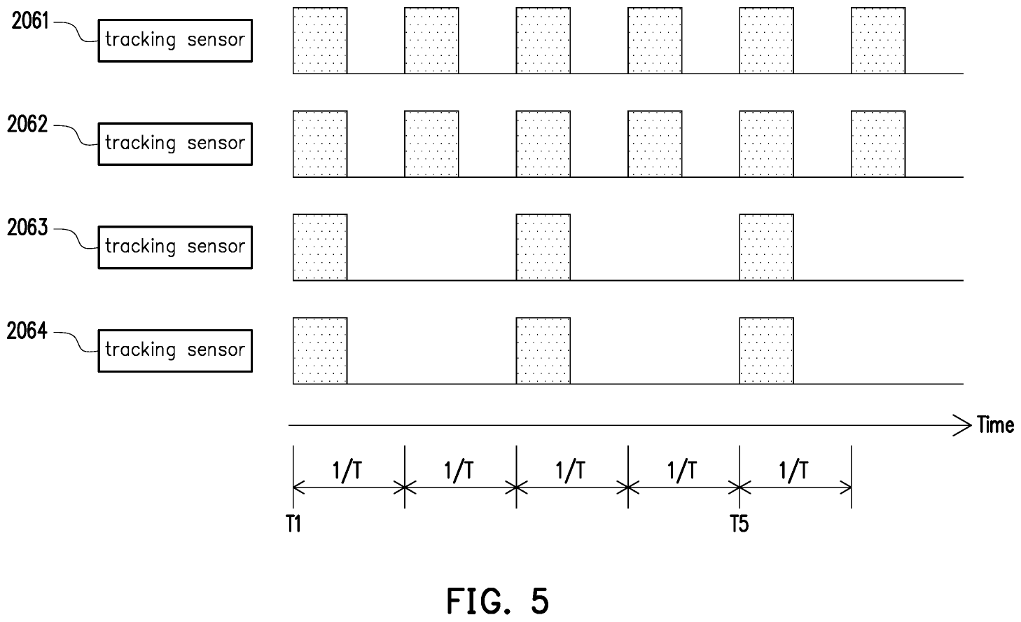

In the first embodiment where the first sensing rate is assumed to be the corresponding frame rate of the first tracking sensor, the processor 204 can, for example, decrease the first sensing rate of the first tracking sensor to be any value less than a predetermined rate of the first sensing rate. For example, if the predetermined rate of the first sensing rate is 60 fps, the processor 204 can decrease the first sensing rate to be any value less than 60 fps, such as 1 fps, 30 fps, and so on. See FIG. 5 for more examples.

FIG. 5 shows a schematic diagram of the sensing rate adjustment of several tracking sensors according to an embodiment of the disclosure. In FIG. 5, the processor 204 determines the sensing result of each of the tracking sensors 2061-2064 and accordingly determine whether each of the tracking sensors 2061-2064 corresponds to the untrackable status or the trackable status.

In FIG. 5, it is assumed that the sensing result of each of the tracking sensors 2061 and 2062 at a timing point T1 indicates that the tracking sensors 2061 and 2062 correspond to the trackable status. In this case, the processor 204 can maintain the sensing rates of the tracking sensors 2061 and 2062 as the predetermined rate (e.g., T fps), and hence the tracking sensors 2061 and 2062 can capture one image (shown as the rectangles with dots) every 1/T second.

In addition, it is assumed that the sensing result of each of the tracking sensors 2063 and 2064 at the timing point T1 indicates that the tracking sensors 2063 and 2064 correspond to the untrackable status. In this case, the processor 204 can decrease the sensing rates of the tracking sensors 2063 and 2064 to be, for example, a half of the predetermined rate (i.e., T/2 fps), and hence the tracking sensors 2063 and 2064 can capture one image every 2/T second, but the disclosure is not limited thereto.

The similar principle introduced in FIG. 5 can be used for the second embodiment where the tracking sensors are implemented as beacon sensors, but the disclosure is not limited thereto.

In one embodiment, the processor 204 can obtain a second sensing result of the first tracking sensor after step S430 and determine whether the second sensing result of the first tracking sensor indicates that the first tracking sensor corresponds to the trackable status.

In the embodiments of the disclosure, the processor 204 can obtain the second sensing result by using the approaches similar to obtaining the first sensing result, which would not be repeated herein.

In one embodiment, in response to determining that the second sensing result of the first tracking sensor indicates that the first tracking sensor corresponds to the trackable status, the processor 204 can determine that the first tracking sensor is changed from the untrackable status to the trackable status; otherwise the processor 204 can determine that the first tracking sensor is maintained as the untrackable status.

In one embodiment, in response to determining that the first tracking sensor is changed from the untrackable status to a trackable status, the processor 204 can increase or recover the first sensing rate of the first tracking sensor; otherwise the processor 204 can maintain the first sensing rate of the first tracking sensor.

For example, assuming that the processor 204 determines that the sensing result of the tracking sensor 2063 at a timing point T5 indicates that the tracking sensor 2063 corresponds to the trackable status, the processor 204 can increase the sensing rate of the tracking sensor 2063 to be any value between T/2 and T or directly recover the sensing rate of the tracking sensor 2063 to be the predetermined rate (i.e., T fps), but the disclosure is not limited thereto.

In one embodiment, in response to determining that the first tracking sensor corresponds to the untrackable status, the processor 204 can record a current pose of the tracking device 200 as a specific pose. In one embodiment, after increasing or recovering the first sensing rate of the first tracking sensor, the processor 204 can determine whether the pose of the tracking device 200 is changed to correspond to the specific pose. In response to determining that the pose of the tracking device 200 is changed to correspond to the specific pose, it represents that the first tracking sensor would correspond to the untrackable status again, and hence the processor 204 can decrease the first sensing rate of the first tracking sensor based on the teachings in the above again, but the disclosure is not limited thereto.

In another embodiment, in response to determining that the first tracking sensor corresponds to the untrackable status, the processor 204 can record a current viewpoint (e.g., the viewpoint that faces the whit wall 301 of FIG. 3) of the first tracking sensor of the tracking device 200 as a specific viewpoint. In one embodiment, after increasing or recovering the first sensing rate of the first tracking sensor, the processor 204 can determine whether a second tracking sensor of the tracking sensors 2061-206N corresponds to the specific viewpoint. In response to determining that the second tracking sensor corresponds to the specific viewpoint, it represents that the second tracking sensor would also correspond to the untrackable status, and hence the processor 204 can decrease the second sensing rate of the second tracking sensor based on the ways similar to decreasing the first sensing rate of the first tracking sensor.

In one embodiment, after increasing or recovering the first sensing rate of the first tracking sensor, the processor 204 can determine whether the first tracking sensor corresponds to the specific viewpoint again. In response to determining that the first tracking sensor corresponds to the specific viewpoint again, it represents that the first tracking sensor correspond to the untrackable status again, and hence the processor 204 can decrease the first sensing rate of the first tracking sensor again, but the disclosure is not limited thereto.

In one embodiment, the processor 204 can decrease the first sensing rate of the first tracking sensor via disabling the first tracking sensor. In particular, the processor 204 can turn off the first tracking sensor, such that the first sensing rate of the first tracking sensor can be regarded as 0, but the disclosure is not limited thereto.

In one embodiment, when determining whether the first tracking sensor is changed from the untrackable status to the trackable status, the processor 204 can monitoring a movement of the tracking device 200 after determining that the first tracking sensor corresponds to the untrackable status. In one embodiment, the tracking device 200 can include a motion detection circuit (e.g., an inertial measurement unit (IMU)) coupled to the processor 204, and the processor 204 can monitor the movement of the tracking device 200 based on the motion data sensed by the motion detection circuit.

In various embodiments, the movement of the tracking device 200 can be characterized by the moving speed and/or the moving distance of the tracking device 200. In one embodiment, the processor 204 can determine whether the moving speed of the movement of the tracking device 200 exceeds a speed threshold or whether a moving distance of the movement of the tracking device exceeds a distance threshold. In the embodiments of the disclosure, the speed threshold can be determined as any value that is enough to regard the tracking device 200 as moving fast, and the distance threshold can be determined as any value that is enough to regard the tracking device 200 as moving far.

In one embodiment, in response to determining that the moving speed of the movement of the tracking device exceeds the speed threshold or the moving distance of the movement of the tracking device exceeds the distance threshold, it represents that the first tracking sensor is possible to provide enough sensing result and/or sensing data for pose tracking. Therefore, the processor 204 can determine that the first tracking sensor is changed from the untrackable status to the trackable status and accordingly increase or recover the first sensing rate of the first tracking sensor.

In one embodiment, whenever the motion detection circuit detects that the tracking device 200 is substantially moving (i.e., not stationary or just slightly moving/shaking), the motion detection circuit can provide an interruption signal to the processor 204. In one embodiment, the processor 204 can determine that each of the tracking sensors 2061-206N is corresponding to the trackable status and accordingly adjusting the sensing rate of each of the tracking sensors 2061-206N.

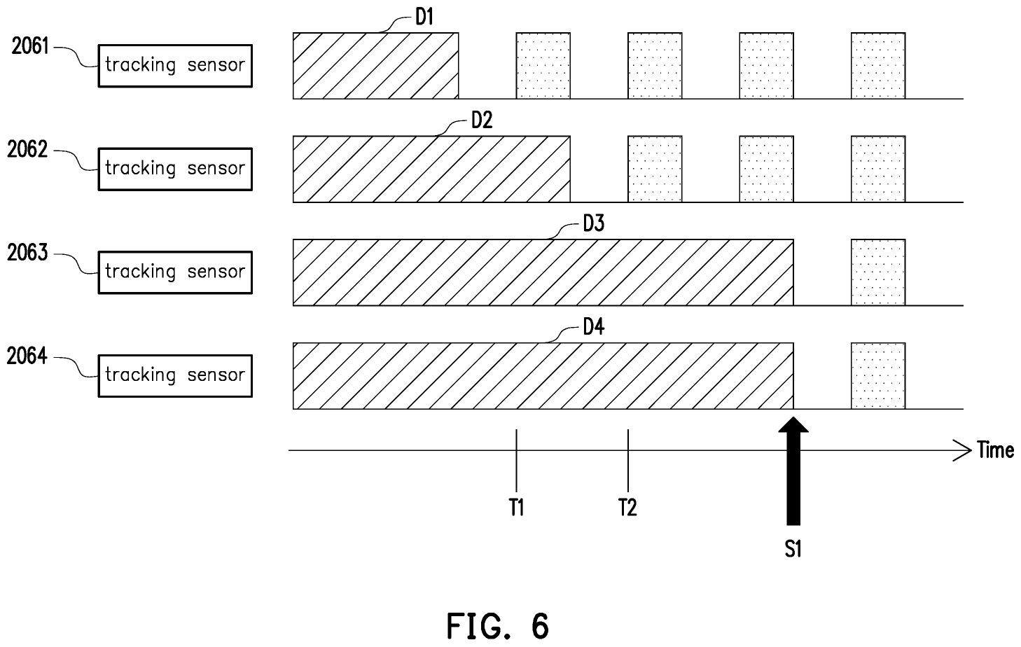

In one embodiment, for those sensors which are already corresponding to the trackable status, the processor 204 can maintain their sensing rates. For those sensors which are changed from corresponding to the untrackable status to corresponding to the trackable status, the processor 204 can increase or recover their sensing rates, but the disclosure is not limited thereto. See FIG. 6 for more examples.

FIG. 6 shows a schematic diagram of the sensing rate adjustment of several tracking sensors according to an embodiment of the disclosure. In FIG. 6, it is assumed that: (1) the tracking sensor 2061 is disabled in a duration D1 and recovers the sensing rate thereof at a timing point T1 due to corresponding to the trackable status; (2) the tracking sensor 2062 is disabled in a duration D2 and recovers the sensing rate thereof at a timing point T2 due to corresponding to the trackable status; (3) the tracking sensors 2063 and 2064 are disabled in durations D3 and D4 due to corresponding to the untrackable status.

In the embodiment, assuming that the processor 204 receives an interruption signal S1 (e.g., the tracking device 200 is determined to be moving fast and/or far enough) at the timing shown in FIG. 6, the processor 204 can determine that each of the tracking sensors 2061-2064 is corresponding to the trackable status and accordingly adjust the sensing rate of each of the tracking sensors 2061-2064. For example, since the tracking sensors 2061 and 2062 are already corresponding to the trackable status, the processor 204 can maintain their sensing rates. Since the tracking sensors 2063 and 2064 are changed from corresponding to the untrackable status to corresponding to the trackable status, the processor 204 can increase or recover their sensing rates, but the disclosure is not limited thereto.

The disclosure further provides a computer readable storage medium for executing the method for managing tracking sensors. The computer readable storage medium is composed of a plurality of program instructions (for example, a setting program instruction and a deployment program instruction) embodied therein. These program instructions can be loaded into the tracking device 200 and executed by the same to execute the method for managing tracking sensors and the functions of the tracking device 200 described above.

In summary, the embodiments of the disclosure can decrease the sensing rate of a tracking sensor when determining that the sensing result and/or sensing data thereof may not be enough for tracking the pose of the tracking device. Accordingly, the power consumption of the tracking sensor can be reduced while reducing the computation loading of the processor. Due to the reduction of power consumption, the tracking device will generate less heat, which reduces the need to install a cooling mechanism in the tracking device. In this way, the structure of the tracking device can be designed to be smaller and lighter, which makes the tracking device more suitable to be worn by the user.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A method for managing tracking sensors, adapted to a tracking device having a plurality of tracking sensors, comprising:
obtaining a first sensing data of a first tracking sensor of the tracking sensors;
determining a first sensing result based on a first sensing data of the first tracking sensor of the tracking sensors; and
in response to the first sensing result of the first tracking sensor indicates that the first tracking sensor corresponds to an untrackable status, decreasing a first sensing rate of the first tracking sensor.

2. The method according to claim 1, further comprising:
controlling the first tracking sensor to capture a first image of an environment; and
detecting a plurality of first environmental landmarks in the first image as the first sensing result of the first tracking sensor.

3. The method according to claim 2, further comprising:
in response to determining that a number of the first environmental landmarks in the first image is less than an amount threshold, determining that the first sensing result of the first tracking sensor indicates that the first tracking sensor corresponds to the untrackable status; and
in response to determining that the number of the first environmental landmarks in the first image is not less than the amount threshold, determining that the first sensing result of the first tracking sensor indicates that the first tracking sensor corresponds to a trackable status.

4. The method according to claim 1, further comprising:
controlling to first tracking sensor to receive at least one beacon from an external beacon source;
in response to determining that a number of the at least one beacon received by the first tracking sensor is less than an amount threshold, determining that the first sensing result of the first tracking sensor indicates that the first tracking sensor corresponds to the untrackable status; and
in response to determining that the number of the at least one beacon received by the first tracking sensor is not less than an amount threshold, determining that the first sensing result of the first tracking sensor indicates that the first tracking sensor corresponds to a trackable status.

5. The method according to claim 1, further comprising:
in response to determining that the first tracking sensor is changed from the untrackable status to a trackable status, increasing or recovering the first sensing rate of the first tracking sensor.

6. The method according to claim 5, further comprising:
monitoring a movement of the tracking device after determining that the first tracking sensor corresponds to the untrackable status; and
in response to determining that a moving speed of the movement of the tracking device exceeds a speed threshold or a moving distance of the movement of the tracking device exceeds a distance threshold, determining that the first tracking sensor is changed from the untrackable status to the trackable status.

7. The method according to claim 5, wherein after the step of decreasing the first sensing rate of the first tracking sensor, the method further comprises:
obtaining a second sensing result of the first tracking sensor; and
in response to determining that the second sensing result of the first tracking sensor indicates that the first tracking sensor corresponds to the trackable status, determining that the first tracking sensor is changed from the untrackable status to the trackable status.

8. The method according to claim 5, further comprising:
in response to determining that the first tracking sensor corresponds to the untrackable status, recording a current pose of the tracking device as a specific pose; and
in response to determining that a pose of the tracking device is changed to correspond to the specific pose after increasing or recovering the first sensing rate of the first tracking sensor, decreasing the first sensing rate of the first tracking sensor.

9. The method according to claim 1, wherein the step of decreasing the first sensing rate of the first tracking sensor comprises:
decreasing the first sensing rate of the first tracking sensor via disabling the first tracking sensor.

10. The method according to claim 1, further comprising:
in response to determining that the first tracking sensor corresponds to the untrackable status, recording a current viewpoint of the first tracking sensor of the tracking device as a specific viewpoint; and
in response to determining that a second tracking sensor of the tracking sensors corresponds to the specific viewpoint, decreasing a second sensing rate of the second tracking sensor.

11. The method according to claim 1, further comprising:
in response to an interruption signal provided by a motion detection circuit of the tracking device, determining that each of the tracking sensors is corresponding to a trackable status and accordingly adjusting a sensing rate of each of the tracking sensors.

12. The method according to claim 11, wherein the step of adjusting the sensing rate of each of the tracking sensors comprises:
recovering the sensing rate of each of the tracking sensors to be a predetermined rate.

13. A tracking device, comprising:
a plurality of tracking sensors;
a non-transitory storage circuit, storing a program code; and
a processor, coupled to the tracking sensors and the non-transitory storage circuit, and accessing the program code to perform:
obtaining a first sensing data of a first tracking sensor of the tracking sensors;
obtaining a first sensing result based on the first sensing data of a first tracking sensor of the tracking sensors; and
in response to the first sensing result of the first tracking sensor indicates that the first tracking sensor corresponds to an untrackable status, decreasing a first sensing rate of the first tracking sensor.

14. The tracking device according to claim 13, wherein each of the tracking sensors is one of a camera and a beacon sensor, and the tracking device is one or a combination of a handheld controller, a head-mounted display, and a tracker.

15. The tracking device according to claim 13, wherein the processor further performs:
controlling the first tracking sensor to capture a first image of an environment; and
detecting a plurality of first environmental landmarks in the first image as the first sensing result of the first tracking sensor.

16. The tracking device according to claim 15, wherein the processor further performs:
in response to determining that a number of the first environmental landmarks in the first image is less than an amount threshold, determining that the first sensing result of the first tracking sensor indicates that the first tracking sensor corresponds to the untrackable status; and
in response to determining that the number of the first environmental landmarks in the first image is not less than the amount threshold, determining that the first sensing result of the first tracking sensor indicates that the first tracking sensor corresponds to a trackable status.

17. The tracking device according to claim 13, wherein the processor further performs:
controlling to first tracking sensor to receive at least one beacon from an external beacon source;
in response to determining that a number of the at least one beacon received by the first tracking sensor is less than an amount threshold, determining that the first sensing result of the first tracking sensor indicates that the first tracking sensor corresponds to the untrackable status; and
in response to determining that the number of the at least one beacon received by the first tracking sensor is not less than an amount threshold, determining that the first sensing result of the first tracking sensor indicates that the first tracking sensor corresponds to a trackable status.

18. The tracking device according to claim 13, wherein the processor further performs:
in response to determining that the first tracking sensor is changed from the untrackable status to a trackable status, increasing or recovering the first sensing rate of the first tracking sensor.

19. The tracking device according to claim 13, wherein the processor further performs:
in response to determining that the first tracking sensor corresponds to the untrackable status, recording a current viewpoint of the first tracking sensor of the tracking device as a specific viewpoint; and
in response to determining that a second tracking sensor of the tracking sensors correspond to the specific viewpoint, decreasing a second sensing rate of the second tracking sensor.

20. A non-transitory computer readable storage medium, the computer readable storage medium recording an executable computer program, the executable computer program being loaded by a tracking device to perform steps of:
obtaining a first sensing data of a first tracking sensor of the tracking sensors;
obtaining a first sensing result based on the first sensing data of a first tracking sensor of the tracking sensors; and
in response to the first sensing result of the first tracking sensor indicates that the first tracking sensor corresponds to an untrackable status, decreasing a first sensing rate of the first tracking sensor.
